(19) United States
(12) Patent Application Publication
(10) Pub. No.: US 2005/0113050 A1
(43) Pub. Date: May 26, 2005

(54) Radio frequency tuning system and method

(75) Inventor: Seung Yong Lee, Kyunggi-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS Co., Ltd., Yongin-shi (KR)

(21) Appl. No.: 10/747,442

(22) Filed: Dec. 30, 2003

(30) Foreign Application Priority Data
Nov. 20, 2003 (KR) 2003-82670

(51) Int. Cl. H04B 1/18

(52) U.S. Cl. 455/154.1

(57) ABSTRACT

A radio frequency tuning system and method. A tuner circuit selectively tunes to only a radio frequency signal of a specific frequency channel among radio frequency signals received through an antenna. A key input unit inputs channel up/down commands so that the corresponding radio frequency channels can be tuned by the tuner circuit. A microcomputer functions to, when the channel up/down commands are successively inputted through the key input unit, send only PLL data based on the last inputted one of the inputted channel up/down commands to the tuner circuit. Therefore, it is possible to eliminate a stabilization time required for every key operation of a radio receiver user so as to perform a faster channel search operation in an auto channel search mode.

### RELATED APPLICATION

The present disclosure relates to subject matter contained in Korean Application No. 10-2003-82670, filed on Nov. 20, 2003, which is herein expressly incorporated by reference in its entirety.

### BACKGROUND OF THE INVENTION

1. Field of the Invention

The present invention relates to a radio frequency tuning system and method for tuning to a radio frequency signal received through an antenna according to a user's selection, and more particularly to a radio frequency tuning system and method wherein a radio frequency channel search is performed within a small amount of time.

2. Description of the Related Art

FIG. 1 is a block diagram showing the configuration of a conventional radio receiver. As shown in this drawing, the conventional radio receiver comprises a phase locked loop (PLL) frequency modulation (FM)/amplitude modulation (AM) tuner circuit.

The tuner circuit generally acts to tune to a desired radio frequency (RF) signal received through an antenna, namely, select a desired channel, receive an RF signal of the selected channel and convert the received RF signal into an intermediate frequency (IF) signal. This tuner circuit is typically applied to radio receivers.

With reference to FIG. 1, a first tuner 2 selectively tunes to only an RF signal of a specific frequency channel among RF signals received through an antenna 1, and an RF amplifier 3 low-noise amplifies the RF signal tuned by the first tuner 2. A second tuner 4 again tunes to a signal component of the specific frequency channel in the RF signal amplified by the RF amplifier 3.

A local oscillator 6 generates an RF signal of a frequency higher by a predetermined frequency than that of a broadcast signal selected by the second tuner 4 to enable a mixer 5 to convert the selected broadcast signal into an IF signal.

A tuning control voltage Vt necessary for the tuning operation must be provided to the first tuner 2, second tuner 4 and oscillator 6. Here, the tuning control voltage Vt is provided by a microcomputer 7 functioning as a controller.

The microcomputer 7 generates PLL data in response to a channel up/down command inputted for frequency channel selection by a user, and sends the generated PLL data to the tuner circuit of the radio receiver composed of the first and second tuners 2 and 4 and the oscillator 6 so that a desired frequency channel can be selected according to the user's selection.

However, the above-mentioned conventional radio receiver has a disadvantage in that, whenever a channel up/down command is inputted through a channel up/down key for an auto channel search by the user, a stabilization time is required until PLL data is sent to the tuner circuit and the tuning operation based on the sent PLL data is completed by the tuner circuit.

For this reason, a large amount of time is required for the auto channel search and, in addition, when an undesired frequency channel is tuned, the user has to wait for a considerable amount of time until the next frequency channel is tuned, resulting in inconvenience of use.

### SUMMARY OF THE INVENTION

Therefore, the present invention has been made in view of the above problems, and it is an object of the present invention to provide a radio frequency tuning system and method wherein, when a channel up/down key operation is performed for tuning of a radio frequency signal of a specific frequency channel, PLL data is limitedly generated, thereby preventing a stabilization time from being required for every PLL data generation in an auto channel search mode and, thus, a large amount of time from being required for channel selection.

In accordance with an aspect of the present invention, the above and other objects can be accomplished by the provision of a radio frequency tuning system comprising: tuner means for selectively tuning to only a radio frequency signal of a specific frequency channel among radio frequency signals received through an antenna; a key input unit for inputting channel up/down commands so that radio frequency channels corresponding thereto can be tuned by the tuner means; and control means for, when the channel up/down commands are successively inputted through the key input unit, sending only phase locked loop (PLL) data based on a last inputted one of the inputted channel up/down commands to the tuner means.

In accordance with another aspect of the present invention, there is provided a radio frequency tuning method comprising the steps of: a), if channel up/down commands are successively inputted, generating and outputting only PLL data based on a last inputted one of the inputted channel up/down commands; b) tuning to a radio frequency channel based on the PLL data generated at the step a); and c) processing and outputting a radio frequency signal of the radio frequency channel tuned at the step b).

In accordance with yet another aspect of the present invention, there is provided a method for performing a radio frequency tuning operation of a radio receiver, the radio receiver including a microcomputer and a tuner circuit, the method comprising the steps of: a) inputting radio frequency channel up/down commands to the microcomputer; b) sensing an open/closed state of a channel up/down key inputting the channel up/down commands; c), upon sensing a transition from the closed state to open state of the channel up/down key at the step b), generating PLL data based on a channel up/down command inputted just before the channel up/down key is open; and d) tuning to a radio frequency channel based on the generated PLL data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a conventional radio receiver;

FIG. 2 is a perspective view showing the outer appearance of an embodiment of a radio receiver to which the present invention is applied;

FIG. 3 is a block diagram showing the configuration of a radio frequency tuning system according to the present invention; and

FIG. 4 is a flow chart illustrating a radio frequency tuning method according to the present invention.

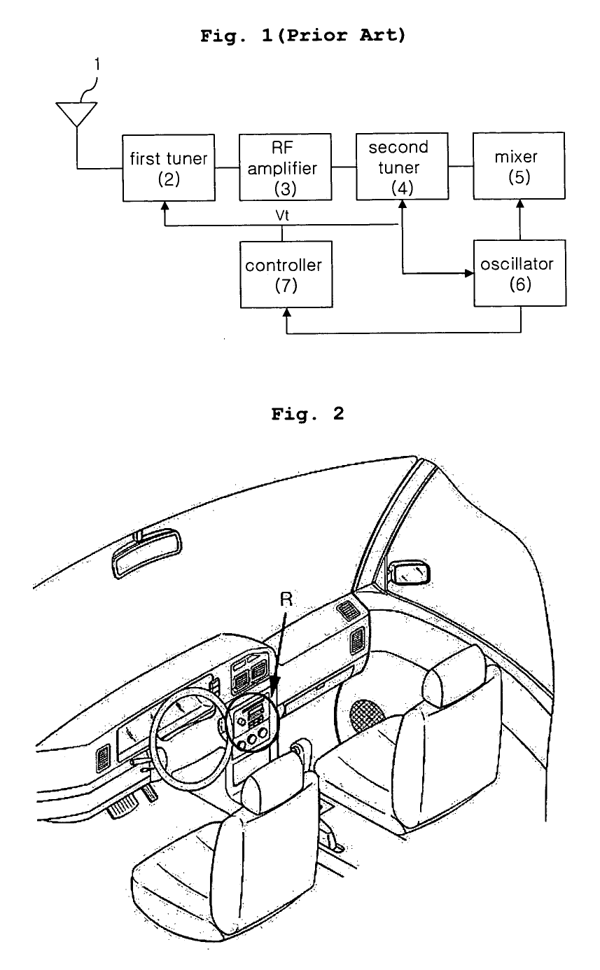

### DESCRIPTION OF THE PREFERRED EMBODIMENTS

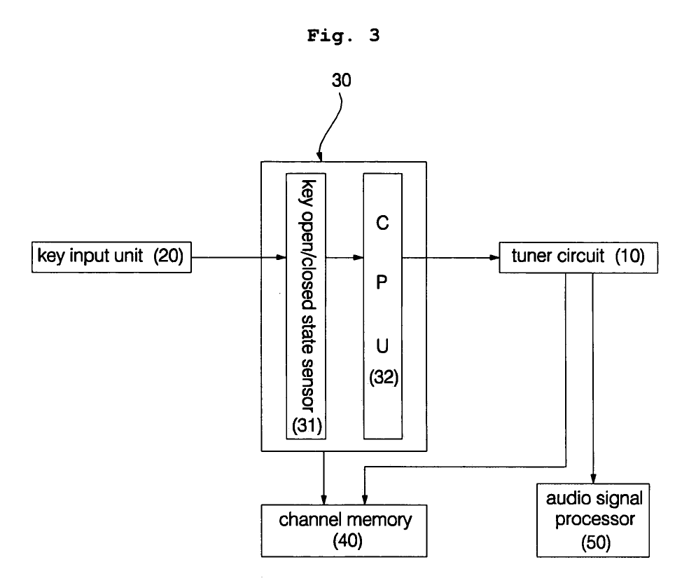

FIG. 2 is a perspective view showing the outer appearance of an embodiment of a radio receiver to which the present invention is applied, and FIG. 3 is a block diagram showing the configuration of a radio frequency tuning system according to the present invention. The radio frequency tuning system according to the present invention is applicable to a radio receiver R in a vehicle having its outer appearance as shown in FIG. 2, and comprises, as shown in FIG. 3, a tuner circuit 10 for tuning to only an RF signal of a selected frequency channel among RF signals received through an antenna, a key input unit 20 for inputting information regarding the frequency channel to be tuned by the tuner circuit 10, and a microcomputer 30 for generating PLL data based on the channel information inputted by the key input unit 20 and sending the generated PLL data to the tuner circuit 10.

In detail, the microcomputer 30 is adapted to generate PLL data based on information about a frequency channel selected by the key input unit 20 and send the generated PLL data to the tuner circuit 10 so that a tuning operation based on the sent PLL data can be performed by the tuner circuit 10. Provided that key commands are successively inputted for an auto channel search through the key input unit 20, the microcomputer 30 generates PLL data of a frequency channel corresponding to the last inputted key command and sends the generated PLL data to the tuner circuit 10.

In a similar manner to that in a conventional radio receiver, the tuner circuit 10 includes tuners, an amplifier and an oscillator and acts to tune to an RF signal received through the antenna.

The microcomputer 30 includes a key open/closed state sensor 31 for receiving a frequency channel signal from the key input unit 20 and sensing an open/closed state of a channel up/down key in the key input unit 20 when the channel up/down key is operated, and a central processing unit (CPU) 32 for generating PLL data according to the state sensed by the key open/closed state sensor 31 and sending the generated PLL data to the tuner circuit 10.

In a conventional radio receiver, a microcomputer has to, in the auto channel search mode, not only send PLL data by steps, but also guarantee stabilization times of the PLL data by steps. However, in the present invention, the microcomputer 30 sends only PLL data of the final step to the tuner circuit 10, so an inter-step channel search speed can increase according to design specifications.

Note that it is effective to guarantee the stabilization time only when a user releases his/her depressing force from the channel up/down key in the key input unit 20 and again applies the force thereto. In this regard, the microcomputer 30 has the key open/closed state sensor 31 and functions to provide the stabilization time according to the open/closed state of the channel up/down key so that an RF signal tuned by the tuner circuit 10 can be stabilized.

The radio frequency tuning system according to the present invention further comprises a channel memory 40 for storing information about frequencies by channels tuned by the tuner circuit 10, and an audio signal processor 50 for processing an audio signal received by the tuner circuit 10 so that it can be outputted from the radio receiver.

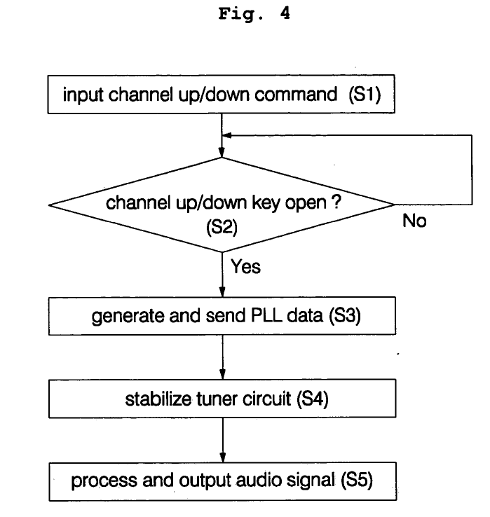

Next, a radio frequency tuning method according to the present invention will be described with reference to FIG. 4.

First, the radio receiver user selects a desired radio frequency channel by operating the channel up/down key, so that a corresponding channel up/down command (frequency channel control command) can be sent to the microcomputer (S1). At this time, the channel up/down key is closed as it is operated by the user.

Upon receiving the channel up/down command, the microcomputer determines through the key open/closed state sensor whether the channel up/down key is open (S2). If the channel up/down key remains closed, not open, the microcomputer recognizes that the user continuously inputs frequency channel control commands through the channel up/down key. As a result, the microcomputer continues to determine through the key open/closed state sensor whether the channel up/down key is open.

On the contrary, in the case where the channel up/down key is determined to be open, the microcomputer generates PLL data based on a frequency channel control command last inputted just before the channel up/down key is open, and sends the generated PLL data to the tuner circuit (S3).

The tuner circuit receives the PLL data from the microcomputer and tunes to a radio frequency signal based on the received PLL data for a PLL stabilization time (S4). At this time, the microcomputer waits until the tuner circuit is stabilized, even though it receives another channel up/down command.

After the tuner circuit completes the tuning operation, the microcomputer returns to the main program to carry out the normal operation, and the radio receiver processes and outputs an audio signal of the tuned frequency channel desired by the user (S5).

Consequently, even though the channel up/down key is kept closed owing to the user's successive key depression to input control commands regarding a plurality of frequency channels to the microcomputer, the microcomputer sends PLL data to the tuner circuit only when the channel up/down key is open. Therefore, it is possible to eliminate a stabilization time required for every key operation so as to perform a faster channel search operation in the auto channel search mode.

As apparent from the above description, the present invention provides a radio frequency tuning system and method wherein a tuner circuit is adapted to selectively tune to only a radio frequency signal of a specific frequency channel among radio frequency signals received through an antenna, a key input unit is adapted to input channel up/down commands so that the corresponding radio frequency channels can be tuned by the tuner circuit, and a microcomputer is adapted to, when the channel up/down commands are successively inputted through the key input unit, send only PLL data based on the last inputted one of the inputted channel up/down commands to the tuner circuit. Therefore, it is possible to eliminate a stabilization time required for every key operation of a radio receiver user so as to perform a faster channel search operation in an auto channel search mode.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A radio frequency tuning system comprising:
tuner means for selectively tuning to only a radio frequency signal of a specific frequency channel among radio frequency signals received through an antenna;
a key input unit for inputting channel up/down commands so that radio frequency channels corresponding thereto can be tuned by said tuner means; and
control means for, when the channel up/down commands are successively inputted through said key input unit, sending only phase locked loop (PLL) data based on a last inputted one of the inputted channel up/down commands to said tuner means.

2. The radio frequency tuning system as set forth in claim 1, wherein said control means is adapted to guarantee a stabilization time until a tuning operation of said tuner means is stabilized after sending said PLL data to said tuner means.

3. The radio frequency tuning system as set forth in claim 1, wherein said control means includes:
a key open/closed state sensor for sensing an open/closed state of a channel up/down key of said key input unit; and
a central processing unit for, upon determining through said key open/closed state sensor that said channel up/down key has made a transition from its closed state to open state, generating said PLL data and sending it to said tuner means.

4. The radio frequency tuning system as set forth in claim 1, further comprising a channel memory for storing information about frequencies by channels tuned by said tuner means.

5. The radio frequency tuning system as set forth in claim 1, further comprising an audio signal processor for generating and outputting an audio signal of said specific frequency channel tuned by said tuner means.

6. A radio frequency tuning method comprising:
a), if channel up/down commands are successively inputted, generating and outputting only PLL data based on a last inputted one of the inputted channel up/down commands;
b) tuning to a radio frequency channel based on said PLL data generated at a); and
c) processing and outputting a radio frequency signal of said radio frequency channel tuned at b).

7. The radio frequency tuning method as set forth in claim 6, wherein a) includes:
a-1) sensing an open/closed state of a channel up/down key inputting the channel up/down commands; and
a-2), upon sensing a transition from the closed state to open state of said channel up/down key, generating said PLL data and sending it to a tuner circuit of a radio receiver.

8. The radio frequency tuning method as set forth in claim 6, wherein b) includes guaranteeing a stabilization time until said radio frequency channel is tuned after said PLL data is sent at a).

9. The radio frequency tuning method as set forth in claim 6, further comprising:
d) storing information about a frequency of said tuned radio frequency channel on a channel-by-channel basis after b) is performed.

10. A method for performing a radio frequency tuning operation of a radio receiver, said radio receiver including a microcomputer and a tuner circuit, said method comprising:
a) inputting radio frequency channel up/down commands to said microcomputer;
b) sensing an open/closed state of a channel up/down key inputting the channel up/down commands;
c), upon sensing a transition from the closed state to open state of said channel up/down key at b), generating PLL data based on a channel up/down command inputted just before said channel up/down key is open; and
d) tuning to a radio frequency channel based on the generated PLL data.

11. A radio frequency tuning system comprising:
a tuner that selectively tunes to only a radio frequency signal of a specific frequency channel among radio frequency signals received through an antenna;
a key input unit that inputs channel up/down commands so that radio frequency channels corresponding thereto can be tuned by said tuner; and
a controller that, when the channel up/down commands are successively inputted through said key input unit, sends only phase locked loop (PLL) data based on a last inputted one of the inputted channel up/down commands to said tuner.

12. The radio frequency tuning system as set forth in claim 11, wherein said controller is configured to guarantee a stabilization time until a tuning operation of said tuner is stabilized after sending said PLL data to said tuner.

13. The radio frequency tuning system as set forth in claim 11, wherein said controller includes:
a key open/closed state sensor that senses an open/closed state of a channel up/down key of said key input unit; and
a central processing unit that, upon determining through said key open/closed state sensor that said channel up/down key has made a transition from its closed state to open state, generates said PLL data and sends it to said tuner.

14. The radio frequency tuning system as set forth in claim 11, further comprising a channel memory that stores information about frequencies by channels tuned by said tuner.

15. The radio frequency tuning system as set forth in claim 11, further comprising an audio signal processor that generates and outputs an audio signal of said specific frequency channel tuned by said tuner.
